(19) United States
(12) Patent Application Publication
(10) Pub. No.: US 2014/0346879 A1
(43) Pub. Date: Nov. 27, 2014

(54) POWER MODULE

(71) Applicant: HON HAI PRECISION INDUSTRY CO., LTD., New Taipei (TW)

(72) Inventor: YU-CHI TSAI, New Taipei (TW)

(73) Assignee: HON HAI PRECISION INDUSTRY CO., LTD., New Taipei (TW)

(21) Appl. No.: 14/285,568

(22) Filed: May 22, 2014

(30) Foreign Application Priority Data
May 22, 2013 (TW) 102118007

(51) Int. Cl. H02M 7/217; H02J 1/00

(52) U.S. Cl. CPC H02M 7/217; H02J 1/00
USPC 307/52; 363/127

(57) ABSTRACT

A power module (10) includes at least one power supply unit (110) and a power distribution board (130) separately located on different circuit boards to prevent any cross-influencing in voltage conversion. The power supply unit (110) includes an AC to DC converter (113) configured to receive an external alternating current (AC), and convert the AC into a first direct current (DC) having a voltage value within a first voltage range. The power distribution board (130) includes at least one voltage converter configured to receive the first DC and convert the first DC into at least one second DC to power the components of a server (20).

### CROSS-REFERENCE TO RELATED APPLICATIONS

This application claims all benefits accruing under 35 U.S.C. §119 from Taiwanese Patent Application No. 10211807, filed on May 22, 2013 in the Taiwanese Intellectual Property Office, the content of which is hereby incorporated by reference.

### FIELD

The present disclosure relates to power supplies.

### BACKGROUND

A server needs a power module to supply power. The converting efficiency of the power module is a very important factor in the performance of the power module. The converting efficiency of power module indicates the ability of the power module for converting an alternating current (AC) into a direct current (DC). Generally, the power module includes an AC to DC converter and a DC to DC converter which are integrally packed. The converting efficiency of the AC to DC converter may be influenced by the DC to DC converter.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a view of a power module used for powering a server according to one embodiment.

FIG. 2 is a block diagram of the power module of FIG. 1 according to a first embodiment.

FIG. 3 is a circuit diagram of an AC to DC converter of the power module of FIG. 2.

FIG. 4 is a block diagram of the power module of FIG. 1 according to a second embodiment of the present disclosure.

### DETAILED DESCRIPTION

Reference will be made to the drawings to describe various embodiments.

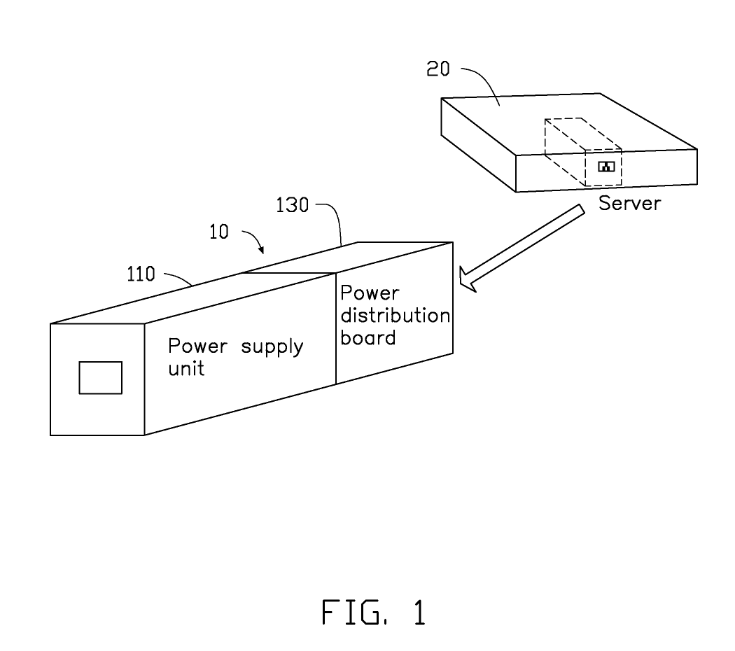

FIG. 1 shows a power module 10 according to one embodiment of the present disclosure. The power module 10 is used to power a server 20, such as to provide an operation voltage to a driving circuit, a CPU, a storage, and other electrical components of the server 20. The power module 10 includes a pair of input terminals 10a to receive an external alternating current (AC) electrical supply, a power supply unit 110, a power distribution board 130, and a plurality of output terminals 10b. The power supply unit 110 and the power distribution board 130 are each located in different circuit boards and are separate from each other. The power supply unit 110 is configured to convert the AC into a first direct current (DC) and output the first DC to the power distribution board 130 through a power cable. The power distribution board 130 is configured to convert the first DC into at least one second DC having a first predetermined voltage value and output the at least one second DC to the server 20 from the output terminals 10b.

The power supply unit 110 receives the AC and converts the AC into the first DC within a first voltage range. The power supply unit 110 includes a first output terminal 110a and a second output terminal 110b configured to output the first DC. In one embodiment, the AC has a working voltage range of 90V˜265V. The first voltage range in DC form can be 13V˜17V.

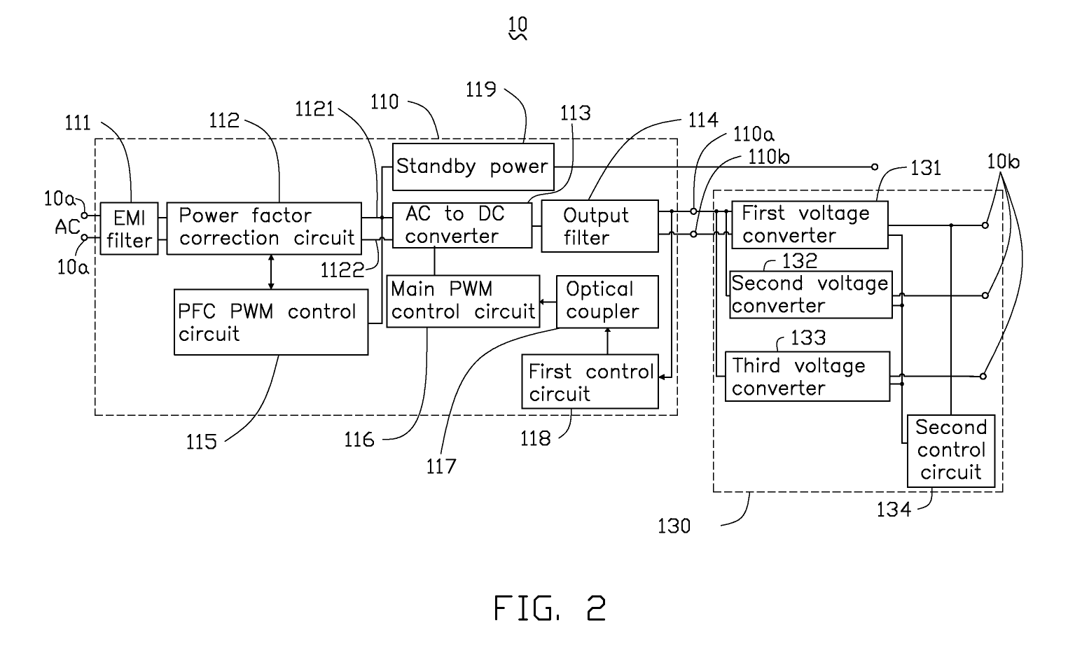

Referring to FIG. 2, the power supply unit 110 includes an electromagnetic interference (EMI) filter 111, a power factor correction (PFC) circuit 112, an AC to DC converter 113, an output filter 114, a power factor correction (PFC) control circuit 115, a main pulse width modulation (PWM) control circuit 116, an optical coupler 117, a first control circuit 118, and a standby power unit 119.

The EMI filter 111 is electrically connected to the pair of input terminals 10a, and configured to receive the AC and filter the AC to eliminate EMI. The EMI filter 111 outputs the AC after being filtered, to the PFC circuit 112.

The PFC circuit 112 is configured to compensate for a phase difference between the current and the voltage of the external AC, to decrease power losses of the power supply unit 110. The PFC 112 includes a third output terminal 1121 and a fourth output terminal 1122, which are configured to output the compensated AC.

The AC to DC converter 113 is electrically connected to the third output terminal 1121 and the fourth output terminal 1122. The AC to DC converter 113 is configured to receive the compensated AC and convert the compensated AC into the first DC.

The main PWM control circuit 116 is electrically connected to the AC to DC converter 113 and configured to output a PWM signal to the AC to DC converter 113.

The PWM signal is configured to adjust the voltage of the first DC within the first voltage range. For example, when the duty cycle of the PWM signal increases, the AC to DC converter 113 increases the voltage of the first DC. Conversely, when the cycle of the PWM signal decreases, the AC to DC converter 113 decreases the voltage of the first DC.

The output filter 114 is electrically connected to the AC to DC converter 113. The output filter 114 is configured to receive and filter the first DC and output the filtered first DC to the first output terminal 110a and the second output terminal 110b.

The PFC control circuit 115 is electrically connected to the third output terminal 1121 and configured to receive the compensated AC and output to the PFC circuit 112 an adjusting signal according to the compensated AC. For example, when the compensated AC is less than a preset voltage value, the PFC control circuit 115 outputs the adjusting signal having a first voltage value to the PFC 112, and the PFC 112 increases the degree of compensation appropriate to the AC. When the compensated AC is greater than a preset voltage value, the PFC control circuit 115 outputs to the PFC 112 an adjusting signal having a second voltage value.

The first control circuit 118 is electrically connected to the output filter 114 and the optical coupler 117. The optical coupler 117 is electrically connected to the main PWM control circuit 116. The first control circuit 118 is configured to detect whether the voltage value of the first DC is within the first voltage range. When the first DC is not within the first voltage range, the first control circuit 118 outputs a first control signal to the optical coupler 117. The optical coupler 117 outputs a second control signal according to the first control signal to the main PWM control circuit 116. The main PWM control circuit 116 regulates the duty cycle of the PWM signal according to the second control signal. In this embodiment, when the second control signal indicates a third voltage value, the main PWM control circuit 116 increases the duty cycle of the PWM signal. When the second control signal indicates a fourth voltage value, the main PWM control circuit 116 decreases the duty cycle of the PWM signal.

The standby power unit 119 is electrically connected to the PFC circuit 112. The standby power unit 119 receives the compensated AC and converts the compensated AC into a standby DC. The standby DC is output to the output terminal 10b to power the server 20 when the power distribution board 130 does not work. The voltage value of the standby DC is 12V.

The power distribution board 130 includes a first voltage converter 131, a second voltage converter 132, a third voltage converter 133, and a second control circuit 134. The first voltage converter 131 is electrically connected to the first output terminal 110a and the second output terminal 110b, the second voltage converter 132 is electrically connected to the first output terminal 110a and the second output terminal 110b, and the third voltage converter 133 is electrically connected to the first output terminal 110a and the second output terminal 110b. The first voltage converter 131 is configured to receive and convert the first DC into a second DC. The second voltage converter 132 is configured to receive and convert the first DC into a third DC. The third voltage converter 133 is configured to receive and convert the first DC into a fourth DC. The second DC, the third DC, and the fourth DC each have different values and can be output to the output terminal 10b to power different components of the server 20. In this embodiment, the voltage value of the second DC is 12V, the voltage value of the third DC is 5V, and the voltage value of the fourth DC is 3.3V.

The second control circuit 134 is electrically connected to the first voltage converter 131, to the second voltage converter 132, and to the third voltage converter 133. The second control circuit 134 is configured to compare a voltage value of the second DC with a first predetermined voltage value, to compare a voltage value of the third DC with a second predetermined voltage value, and to compare a voltage value of the fourth DC with a third predetermined voltage value. When the voltage value of the second DC is different from the first predetermined voltage value, the second control circuit 134 outputs a first regulating signal to the first voltage converter 131 to regulate the second DC to have the first predetermined voltage value. When the voltage value of the third DC is different from the second predetermined voltage value, the second control circuit 134 outputs a second regulating signal to the second voltage converter 132 to regulate the second DC to have the second predetermined voltage value. When the voltage value of the fourth DC is different from the third predetermined voltage value, the second control circuit 134 outputs a third regulating signal to the third voltage converter 133 to regulate the fourth DC to have the third predetermined voltage value.

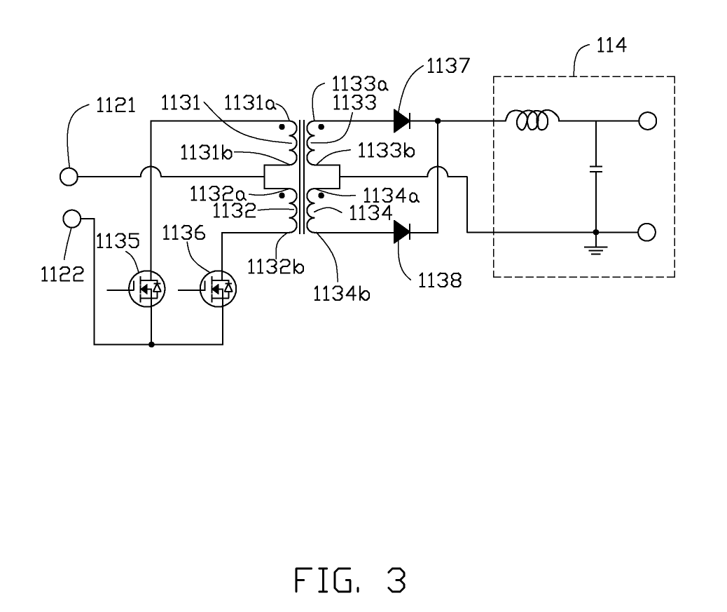

Referring to FIG. 3, the AC to DC converter 113 includes a first input winding 1131, a second input winding 1132, a first output winding 1133, a second output winding 1134, a first switch 1135, a second switch 1136, a first diode 1137, and a second diode 1138.

The first input winding 1131 is coupled to the third output terminal 1121 and the fourth output terminal 1122, and the second input winding 1132 is coupled to the third output terminal 1121 and the fourth output terminal 1122. The first input winding 1131 and the second input winding 1132 receive the compensated AC, and respectively transmit the compensated AC to the first output winding 1133 and the second output winding 1134 using an electromagnetic induction means. The first input winding 1131 includes a first non-inverting terminal 1131a and a first inverting terminal 1131b; the second input winding 1132 includes a second non-inverting terminal 1132a and a second inverting terminal 1132b. The first non-inverting 1131a is electrically coupled to the fourth output terminal 1122 through the first switch 1135. The first inverting terminal 1131b is electrically connected to the third output terminal 1121. The second non-inverting terminal 1132a is electrically connected to the third output terminal 1121, and the second inverting terminal 1132b is electrically coupled to the fourth output terminal 1122 through the second switch 1136.

The first output winding 1133 includes a third inverting terminal 1133a and a third non-inverting terminal 1133b and the second output winding 1134 includes a fourth inverting terminal 1134a and fourth non-inverting terminal 1134b. The third inverting terminal 1133a is electrically coupled to the output filter 114 through the first diode 1137, and the third non-inverting terminal 1133b is coupled to the fourth inverting terminal 1134a and the same time grounded. The fourth non-inverting terminal 1134b is electrically coupled to the output filter 114 through the second diode 1138.

The first switch 1135 and the second switch 1136 are transistors. The gate of the transistor is electrically connected to the PWM control circuit 116 and controlled by the PWM control circuit 116. The source and drain of the transistor electrically connect to the first input winding 1131 and the fourth output terminal 1122 respectively, or can be electrically connect to the second input winding 1132 and the fourth output terminal 1122 respectively.

For example, referring to FIGS. 2-3, the AC is being input to the EMI filter 111. The AC is filtered by the EMI filter 111 and output to the PFC circuit 112. Then, the filtered AC is compensated by the PFC circuit 112. The filtered and compensated AC is output to the AC to DC converter 113. The AC to DC converter 113 converts the filtered and compensated AC into the first DC, then the first DC is output to the output filter 114. The output filter 114 filters the first DC and outputs the first DC after filtering to the first output terminal 110a and the second output terminal 110b.

The first DC after filtering is output to the power distribution board 130. The first voltage converter 131 receives and converts the filtered first DC into the second DC. The second voltage converter 132 receives and converts the filtered first DC into the third DC. The third voltage converter 133 receives and converts the filtered first DC into the fourth DC. Each of the second, third, and fourth DCs can be output to the output terminal 10b.

When the voltage value of second DC is different from the first predetermined voltage value, the second control circuit 134 outputs a first regulating signal to the first voltage converter 131 to regulate the second DC to have the first predetermined voltage value. When the voltage value of the third DC is different from the second predetermined voltage value, the second control circuit 134 outputs a second regulating signal to the second voltage converter 132 to regulate the third DC to have the second predetermined voltage value. When the voltage value of the fourth DC is different from the third predetermined voltage value, the second control circuit 134 outputs a third regulating signal to the third voltage converter 133 to regulate the fourth DC to have the third predetermined voltage value.

The AC to DC converter 133 in the power supply unit 110 and the DC to DC converter 131-133 in the power distribution board 130 are located on different circuit boards, the converting efficiency of the AC to DC is not influenced by the DC to DC converter.

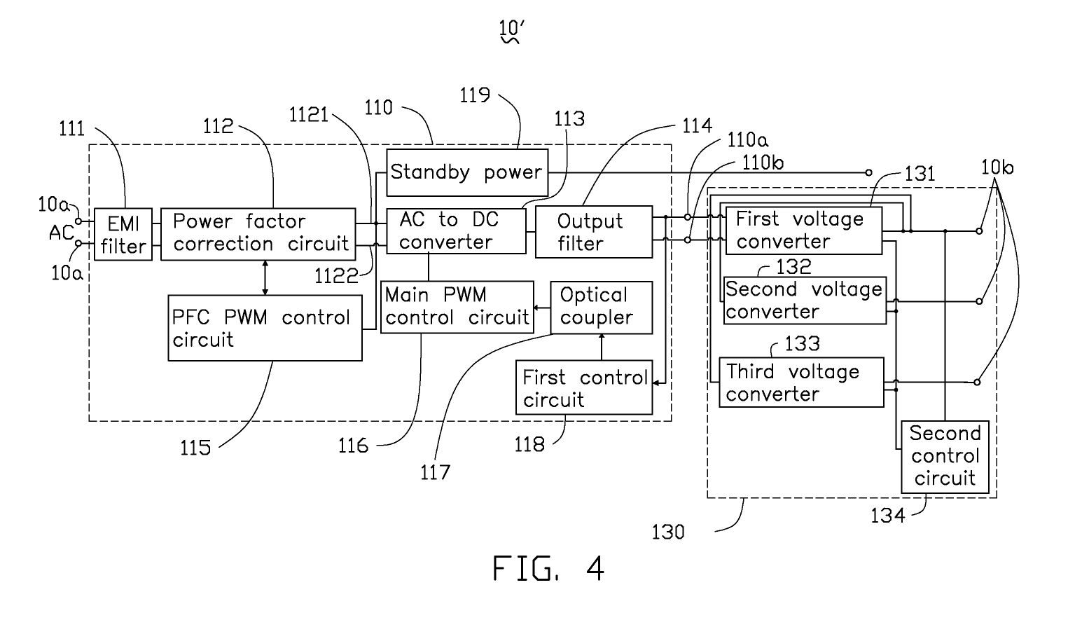

Referring to FIG. 4, a second embodiment of the present disclosure is shown. A power module 10′ in this second embodiment is similar to the above-described power module 10. The two power modules differ in that the second voltage converter 132 and the third voltage converter 133 are electrically connected to the first voltage converter 131. The second voltage converter 132 receives the second DC and converts the second DC into the third DC and the third voltage converter 133 receives the second DC and converts the second DC into the fourth DC.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in the matters of shape, size and arrangement of parts within the principles of the present disclosure to the full extent indicated by the broad general meaning of the terms in which the appended claims are expressed.

What is claimed is:

1. A power module (10), comprising:
at least one power supply unit (110), each of the at least one the power supply unit (110) comprising an AC to DC converter (113) configured to convert an external alternating current (AC) into a first direct current (DC) having a voltage value within a first voltage range;
a power distribution board (130) comprising at least one voltage converter configured to receive the first DC and convert the first DC into at least one second DC having a first predetermined voltage value to power a server;
wherein the at least one power supply unit (110) and the power distribution (130) are separately located on different circuit boards.

2. The power module of claim 1, wherein the first voltage range is 13V˜17V.

3. The power module of claim 1, wherein the at least one power supply unit (110) comprises a power factor correction (PFC) circuit (112), an output filter (114) and a main pulse width modulation (PWM) circuit (116), the PFC circuit (112) is configured to compensate a phase difference of the AC and output the compensated AC to the AC to DC converter (113), the main PWM circuit (116) is configured to output a PWM signal to adjust the voltage value of the first DC, and the output filter (114) is configured to filter the first DC.

4. The power module of claim 3, wherein the at least one power supply unit (110) further comprises a first control circuit and an optical coupler (117), the first control circuit (118) is electrically connected to the output filter (114) and the optical coupler (117), the first control circuit (118) is configured to detect whether the voltage value of the first DC is within the first voltage range, when the first direct current is not within the first voltage range, the first control circuit (118) outputs a first control signal to the optical coupler (117), the optical coupler (117) is electrically connected to the main PWM control circuit (116) and configured to output a second control signal to the main PWM control circuit (116) according to the first control signal.

5. The power module of claim 4, wherein the main PWM control circuit (116) regulates a duty cycle of the PWM signal according to the second control signal.

6. The power module of claim 3, wherein the power supply unit includes a power factor correction (PFC) control circuit (115) electrically connected to the PFC circuit (112) and configured to receive the compensated AC and output to the PFC circuit 112 an adjusting signal according to the compensated AC.

7. The power module of claim 1, wherein the at least one voltage converter comprises a first voltage converter (131), a second voltage converter (132), and a third voltage converter (133), the first voltage converter (131) is configured to convert the first DC into the second DC, the second voltage converter (132) is configured to convert the first DC into a third DC, and the third voltage converter (133) is configured to convert the first DC into a fourth DC.

8. The power module of claim 7, wherein the power distribution board (130) comprises a second control circuit (134), the second control circuit (134) is electrically connected to the first voltage converter (131), to the second voltage converter (132) and to the third voltage converter (133), the second control circuit (134) is configured to compare the second DC with a first predetermined voltage value, to compare the third DC with a second predetermined voltage value, and to compare the fourth DC with a third predetermined voltage value; when the voltage value of second DC is different from the first predetermined voltage value, the second control circuit (134) outputs a first regulating signal to the first voltage converter (131) to regulate the second DC to have the first predetermined voltage value; when the voltage value of the third DC is different from the second predetermined voltage value, the second control circuit (134) outputs a second regulating signal to the second voltage converter (132) to regulate the third DC to have the second predetermined voltage value; when the voltage value of the fourth DC is different from the third predetermined voltage value, the second control circuit (134) outputs a third regulating signal to the third voltage converter (133) to regulate the fourth DC to have the third predetermined voltage value.

9. The power module of claim 1, wherein the at least one voltage converter comprises a first voltage converter (131), a second voltage converter (132), and a third voltage converter (133), the first voltage converter (131) is configured to convert the first DC into the second DC, the second voltage converter (132) is electrically connected to the first voltage convert (131) and configured to convert the second DC into a third DC, the third voltage converter (133) is electrically connected to the first voltage convert (131) and configured to convert the second DC into a fourth DC.

10. A power module, comprising:
an AC to DC converter (113);
the AC to DC converter (113) is configured for receiving an external alternating current (AC), and converting the AC into a first direct current (DC) within a first voltage range ;
at least one voltage converter (131) configured for receiving the first DC, and converting the first DC into at least one of second DC having a first predetermined voltage value to power a server;
wherein the AC to DC converter (113) and the voltage converter (131) are separately located on two different circuit boards.

11. The power module of claim 10, wherein the first voltage range is 13V˜17V.

12. The power module of claim 1, wherein the AC to DC converter (113) is located at a circuit board of an at least one power supply unit (110), the at least one power supply unit (110) comprises a power factor correction (PFC) circuit (112), an output filter (114) and a main pulse width modulation (PWM) circuit (116), the PFC circuit (112) is configured to compensate a phase difference of the AC and output the compensated AC to the AC to DC converter (113), the main PWM circuit (116) is configured to output a PWM signal and adjust the voltage value of the first DC according to a duty cycle of the PWM signal, and the output filter (114) is configured to filter the first DC.

13. The power module of claim 12, wherein the at least one power supply unit (110) further comprises a first control circuit (118) and an optical coupler (117), the first control circuit (118) is electrically connected to the output filter (114) and the optical coupler (117), the first control circuit (118) is configured to detect whether the first DC is within the first voltage range, when the first DC is not within the first voltage range, the first control circuit (118) outputs a first control signal to the optical coupler (117); the optical coupler (117) is electrically connected to the main PWM control circuit (116), the optical coupler (117) is configured to output a second control signal to the main PWM control circuit (116) according to the first control signal.

14. The power module of claim 13, wherein the main PWM control circuit (116) regulates a duty cycle of the PWM signal according to the second control signal.

15. The power module of claim 3, wherein the at least one power supply unit (110) includes a power factor correction (PFC) control circuit (115), the PFC control circuit (115) is electrically connected to the PFC circuit (112), the PFC control circuit (115) is configured to receive the compensated AC and output to the PFC circuit 112 an adjusting signal according to the compensated AC.

16. The power module of claim 10, wherein the at least one voltage converter is located on a power distribution board (130), the at least one voltage converter comprises a first voltage converter (131), a second voltage converter (132), and a third voltage converter (133), the first voltage converter (131) is configured to convert the first DC into the second DC, the second voltage converter (132) is configured to convert the first DC into a third DC, the third voltage converter (133) is configured to convert the first DC into a fourth DC.

17. The power module of claim 16, wherein the power distribution board (130) comprises a second control circuit (134), the second control circuit (134) is electrically connected to the first voltage converter (131), to the second voltage converter (132), and to the third voltage converter (133), the second control circuit (134) is configured to compare the second DC with a first predetermined voltage value, to compare the third DC with a second predetermined voltage value, and to compare the fourth DC with a third predetermined voltage value; when the voltage value of second DC is different from the first predetermined voltage value, the second control circuit (134) outputs a first regulating signal to the first voltage converter (131) to regulate the second DC to have the first predetermined voltage value; when the voltage value of the third DC is different from the second predetermined voltage value, the second control circuit (134) outputs a second regulating signal to the second voltage converter (132) to regulate the third DC to have the second predetermined voltage value; when the voltage value of the fourth DC is different from the third predetermined voltage value, the second control circuit (134) outputs a third regulating signal to the third voltage converter (133) to regulate the fourth DC to have the third predetermined voltage value.

18. The power module of claim 10, wherein the at least one voltage converter is located on a power distribution board (130), the at least one voltage converter comprises a first voltage converter (131), a second voltage converter (132), a third voltage converter (133), the first voltage converter (131) is configured to convert the first DC into a second DC, the second voltage converter (132) is electrically connected to the first voltage convert (131) and configured to convert the second DC into a third DC, the third voltage converter (133) is electrically connected to the first voltage convert (131) and configured to convert the second DC into a fourth DC.
